(19) United States
(12) Patent Application Publication
(10) Pub. No.: US 2019/0376396 A1
(43) Pub. Date: Dec. 12, 2019

(54) TURBINE BLISK AND PROCESS OF MAKING

(71) Applicant: Rolls-Royce North American Technologies Inc., Indianapolis, IN (US)

(72) Inventor: Douglas D. Dierksmeier, Franklin, IN (US)

(73) Assignee: Rolls-Royce North American Technologies Inc.

(21) Appl. No.: 16/006,030

(22) Filed: Jun. 12, 2018

(51) Int. Cl. F01D 5/34; B23K 20/12; B23P 15/00; F01D 5/08

(52) U.S. Cl. CPC F01D 5/34; B23K 20/12; B23K 2101/001; F01D 5/085; B23P 15/006

(57) ABSTRACT

A turbine blisk for use in a turbine rotor assembly in a gas turbine engine includes a turbine blade having a base end with a discrete bonding surface; an intermediate component having a first bonding surface and a second bonding surface; and a portion of a rotor disc having an outer surface that includes a bonding area. The discrete bonding surface of the base end of the turbine blade is attached to the first bonding surface of the intermediate component, thereby forming a first joint. The second bonding surface of the intermediate component is attached to the bonding area of the outer surface of the rotor disc, thereby forming a second joint. The first joint includes a diffusion bond, while the second joint includes a linear friction weld.

### TECHNICAL FIELD

This disclosure relates to gas turbine engines. More specifically, this disclosure relates to a turbine rotor assembly and turbine blisks used therein.

### BACKGROUND

The statements in this section merely provide background information related to the present disclosure and may not constitute prior art.

In many applications, the use of a turbine engine is desirable over the use of other types of turbine engines. However, during operation of a turbine engine, the turbine rotor assembly may be subjected to high temperatures and substantial stresses. In order to increase the performance of the turbine engine, a higher rotational velocity and higher temperatures of the turbine rotor assembly is necessary.

The features of conventional turbine engines are usually limited by the design and manufacturing processes associated with the turbine rotor assemblies incorporated therein. For example, many conventional turbine rotor assemblies include individual blades that are inserted into turbine disc attachment slots (dovetails or firtrees). In addition, the dovetail or firtree attachment features of turbine blades and disc are subject to stresses during operation that increase with higher rotor speeds. The allowable material stresses decease with increasing temperature, limiting the capability of a conventional attachment. Accordingly, the attachment of the turbine blade to the rotor disc are subject to bearing surface fretting along with low cycle fatigue (LCF), and fatigue crack growth (FCG) encountered in the small fillet areas during operation.

### DRAWINGS

In order that the disclosure may be well understood, there will now be described various forms thereof, given by way of example, reference being made to the accompanying drawings, in which:

FIG. 1 is a schematic side view representation of a turbine blisk formed according to the teachings of the present disclosure;

FIG. 2 is a schematic front view representation of another turbine blisk formed according to the teachings of the present disclosure;

FIG. 3 is a schematic side view representation of a portion of a turbine rotor assembly that includes a plurality of the turbine blisks formed according to FIG. 1; and

FIG. 4 is a flowchart of a process used to form a turbine blisk according to the teachings of the present disclosure.

The drawings described herein are for illustration purposes only and are not intended to limit the scope of the present disclosure in any way.

### DETAILED DESCRIPTION

The present disclosure generally provides a turbine blisk that is capable of withstanding the increase in rotational velocity and temperature of the rotor in a turbine engine. The following description is merely exemplary in nature and is in no way intended to limit the present disclosure or its application or uses. For example, the turbine blisks made and used according to the teachings contained herein are described throughout the present disclosure in conjunction with a turbine engine in order to more fully illustrate the composition and the use thereof. The incorporation and use of such turbine blisks in other industrial and military applications that may include various types of compressors, fans, and engines are contemplated to be within the scope of the present disclosure.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of’ an element are used interchangeably and may have the same meaning. These terms, which refer to the inclusion of a single element or a plurality of the elements, may also be represented by the suffix “(s)” at the end of the element. For example, “at least one source”, “one or more sources”, and “source(s)” may be used interchangeably and are intended to have the same meaning.

For purposes of promoting an understanding of the principles of the present disclosure, reference will now be made to various embodiments illustrated in the drawings, and specific language will be used to describe the same. It should be understood that throughout the description, corresponding reference numerals indicate like or corresponding parts and features. One skilled in the art will further understand that any properties reported herein represent properties that are routinely measured and may be obtained by multiple different methods. The methods described herein represent one such method and other methods may be utilized without exceeding the scope of the present disclosure.

No limitation of the scope of the present disclosure is intended by the illustration and description of certain embodiments herein. In addition, any alterations and/or modifications of the illustrated and/or described embodiment(s) are contemplated as being within the scope of the present disclosure. Further, any other applications of the principles of the present disclosure, as illustrated and/or described herein, as would normally occur to one skilled in the art to which the disclosure pertains, are contemplated as being within the scope thereof.

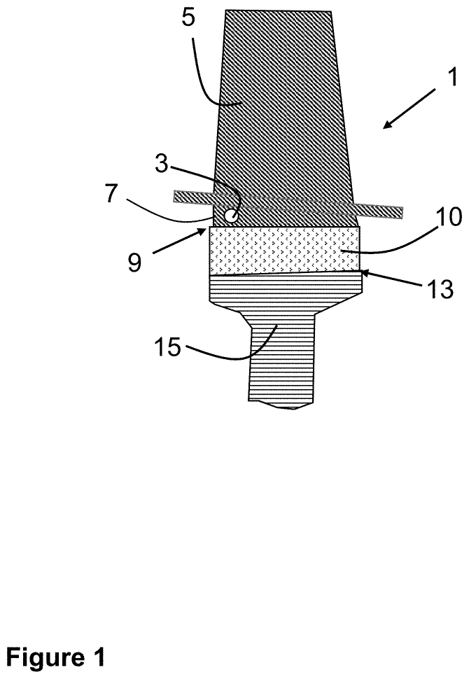

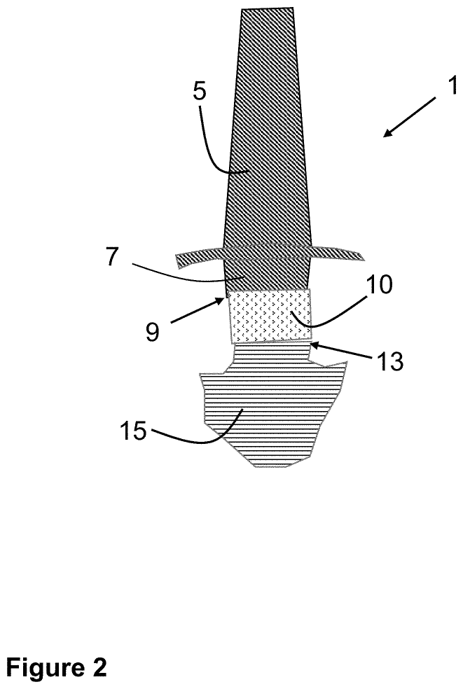

Referring to FIGS. 1 and 2, a turbine blisk 1 for use in a gas turbine engine is provided. This turbine blisk 1 generally comprises, consists of, or consists essentially of a turbine blade 5, an intermediate component 10, and a portion of a rotor disc 15. Each of the turbine blade 5, intermediate component 10, and rotor disc 15 comprises one or more bonding surfaces or areas. More specifically, the turbine blade 5 includes a base end 7 that has a discrete bonding surface; the intermediate component 10 includes both a first bonding surface and a second bonding surface; and the outer surface of the rotor disc 15 includes a bonding area. The discrete bonding surface of the base end 7 of the turbine blade 5 is attached to the first bonding surface of the intermediate component 10, thereby forming a first joint 9, which comprises a diffusion bond. The second bonding surface of the intermediate component 10 is attached to the bonding area of the outer surface of the rotor disc 15, thereby forming a second joint 13, which comprises a linear friction weld.

The turbine blisks 1 may also be known as integrally bladed rotors (IBRs). The turbine blisks 1 of the present disclosure reduce the need to use multi-axis machine tools and advanced CNC software in order to machine the complicated shape of the blade and rotor disc in each turbine blisk as a single part from difficult to cut metal-based alloys. Conventionally, cast blisk airfoils are manufactured using equiaxed materials which have lower stress and temperature capabilities when compared to the possible airfoil materials (such as single crystal materials) of the present disclosure. The milling and/or cutting equipment that is conventionally used to form a single part turbine blisk needs to meet stringent productive and fail-safe machining requirements. Rather, the turbine blisks 1 of the present disclosure, with the incorporation of the intermediate component 10 and the formation of a first joint 9 with the blade 5 and a second joint 13 with the rotor disc 15 allows for a simplification in the manufacturing process.

Another way of forming conventional turbine blisks is to directly bond all of the blades directly to the rotor disc in a single operation, which makes it extremely difficult to obtain a consistent bond surface pressure value and/or distribution. Thus, another advantage provided by the turbine blisks 1 of the present disclosure includes being able to obtain a consistent pressure distribution between the blade 5 and the intermediate component 10 due to the ability to bond one blade 5 to an intermediate component 10 in a singular manner, e.g., one blade at a time.

The use of the turbine blisks 1 of the present disclosure allows for the design of the engine to operate at higher temperatures, which result from a higher compressor temperature (CDT) and/or a higher rotor inlet temperature (RIT). The use of higher CDT and RIT reduces fuel burn, weight, and cost.

The use of the turbine blisks 1 of the present disclosure also allows the turbine design engineer to increase the “AN²” parameter in the engine design. The “A” in this “AN²” parameter represents the area of the flow path looking down the engine centerline, while the “N” is the rotational speed. A higher “AN²” value improves engine performance, which includes without limitation, turbine efficiency and turbine work extraction.

In addition, the diffusion bonded joint 9 formed between the between the blade 5 and the intermediate component 10 of the turbine blisk 1 of the present disclosure can easily be inspected because the distance between the bonded joint 9 and the probe used in a conventional inspection method would be minimized and within acceptable industry parameters. Thus, turbine blisks 1 with an unacceptable joint could be rejected or repaired early in the manufacturing process, thereby, reducing cost and/or the generation of waste or scrap. Finally, the performance of the second joint 13 would not be considered a potential failure site because the linear friction weld formed between the intermediate component 10 and rotor disc 15 would be formed between materials that are similar in composition; alternatively, identical in composition.

Similar to repairing a rejected blade, a damaged blade that comprises the turbine blisk 1 of the present disclosure may be subject to repairability. For example, a damaged portion of the blade may be cut off below the intersection of the rotor disc and the intermediate component. A new blade with an intermediate component attached thereto may then be attached to the rotor disc.

The turbine blade 5 generally comprises at least one of a single crystal material or an equiax material. Alternatively, the single crystal or equiax material comprises a nickel-based alloy, with one or more other minor metals. These other metals may include without limitation, chromium, cobalt, tungsten, tantalum, aluminum, and/or rhenium. The amount of each additional metal may be in the range of about 5 wt. %; alternatively, greater than 5 wt. % based on the overall weight of the alloy An example of such a nickel-based alloy may include, but not be limited to, a Mar-M-247 superalloy.

The intermediate component 10 and the rotor disc 15 are generally comprised of a similar material; alternatively, the same material. Alternatively, the rotor disc 15 and the intermediate component 10 comprise, consist of, or consist essentially of one or more metal-based superalloys. The metal-based superalloys, may include but not be limited to nickel-based superalloys.

Still referring to FIGS. 1 and 2, the first bonding surface and the second bonding surface of the intermediate component 10 may be substantially flat. Similarly, the base end 7 of the turbine blade 5 may include a base surface that is substantially flat, such that this flat base surface represents the discrete bonding surface of the turbine blade 5 that is attached to the first bonding surface of the intermediate component 10 to form the first joint 9. In addition, the bonding area of the rotor disc 15 that forms the second joint 13 with the second bonding surface of the intermediate component 10 may also be substantially flat.

For the purpose of this disclosure, diffusion bonding represents a solid-state bonding technique that is capable of joining similar and dissimilar metals. It operates on the principle of solid-state diffusion, wherein the atoms of two solid, metallic surfaces will become interspersed together over time. The diffusion bonding of the turbine blade 5 to the intermediate component 10 may be accomplished using an elevated temperature, such as for example greater than 50% of the absolute melting temperature of the materials. Diffusion bonding may be implemented by applying high pressure, in conjunction with the high temperature, to assist the surface atoms of the materials to become interdispersed, thereby forming the bonded joint 9.

For the purpose of this disclosure, linear friction welding is a solid-state process in which one part moves in a linear motion at high speed and is pressed against another part that is held stationary or moving in an opposite direction. The resulting friction heats the parts, causing them to forge together. When the oscillation stops, the parts cool to form a forged-quality weld.

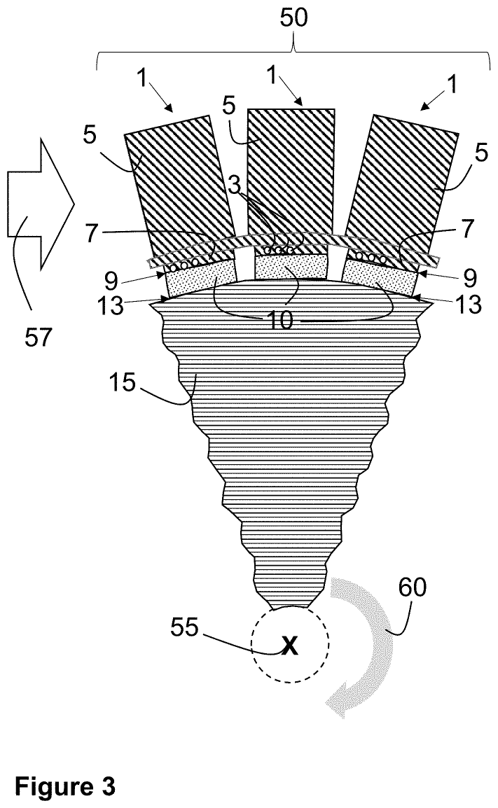

According to another aspect of the present disclosure, the turbine blisks may be part of a turbine rotor assembly used in a turbine engine. Referring now to FIG. 3, a turbine rotor assembly 50 is provided. This turbine rotor assembly 50 generally comprises a rotor disc 15 that has an outer surface, which includes one or more bonding areas; a plurality of turbine blades 5; and a plurality of intermediate components 10. Each of the turbine blades 5 includes a base end 7 that has a discrete bonding surface and each of the intermediate components 10 includes a first bonding surface and a second bonding surface. The discrete bonding surface of each turbine blade 5 is attached to the first bonding surface of one of the intermediate components 10 by a diffusion bond forming a first joint 9 and the second bonding surface of each of the intermediate components 10 is attached to one of the discrete bonding surfaces of the rotor disc 15 by a linear friction weld forming a second joint 13. Each of the turbine blades 5 is separate and distinct from the other turbine blades 5 that are attached to the rotor disc 15.

When desirable, each of the turbine blades 5 may comprise at least one cooling feature. For example, each turbine blade 5 may include a base end 7 that incorporates a one or more cooling holes 3 as shown in FIGS. 1 and 3.

Referring once again to FIG. 3, the turbine rotor assembly 50 may be a mechanical component of a turbine engine that extracts energy from a fluid flow 57. The turbine rotor assembly 50 may rotate 60 about a rotational axis 55 and drive a shaft in the turbine engine. The fluid flow 57 in the turbine engine may be radial, or semi-radial, to the rotational axis 55 of the turbine rotor assembly 50. The fluid flow 57 may apply force to the turbine blades 5, which results in the rotation 60 of the turbine rotor assembly 50. The turbine rotor assembly 50 may be located in any portion of the turbine engine. For example, the turbine rotor assembly 50 may be located in the exhaust portion of the turbine engine. Thus, the turbine rotor assembly 50 may experience substantial mechanical stress due to the pressures, extreme thermodynamics, and other factors present in a hot section, or other sections, of the turbine engine.

The individual components of the turbine rotor assembly 50 are assembled separately as discussed above and as further defined herein. Accordingly, the turbine rotor assembly 50 is a combination of individual components joined together. For instance, the turbine rotor assembly 50 includes a rotor disc 15 and discrete turbine blisks 1 that include turbine blades 5 and intermediate components 10 attached to a portion of the rotor disc 15 as illustrated in FIGS. 1-3. The turbine blisks 1 and/or other components of the turbine rotor assembly 50 may include, for example, features suitable to improve the performance, efficiency, sustainability, feasibility, and other design considerations of the turbine engine. A manufacturing process may produce the individual components of the turbine rotor assembly 50, such as the turbine blades 5, the intermediate components 10, and the rotor disc 15 before joining the components.

The rotor disc 15 is a component of the turbine rotor assembly 50 that rotates 60 about the rotational axis 55 of the turbine engine. In some applications, the rotor disc 15 may be connected with a shaft that drives the turbine engine. Other components of the turbine rotor assembly 50, such as the turbine blades 5 when joined to the rotor disc 15 will rotate with the rotor disc 15. The shape of the rotor disc 15 may include, but not be limited to, a cylinder, a cone, or any other shape. For example, the rotor disc 15 may taper along a curve convergent to the rotational axis 55 of the rotor disc 15.

Each of the turbine blades 5, such as the turbine blades illustrated in FIGS. 1-3, may be a structure responsive to fluid flow 57 on the turbine rotor assembly 50. The turbine blades 5 may include a curved portion to receive fluid flow 57 in a turbine engine. For example, the turbine blade 5 may include an airfoil, a spar, a coversheet, or any other component of a blade. In some applications, each of the turbine blades 5 may include a dual wall airfoil. In addition, each of the turbine blades 5 may be separate and distinct from the other turbine blades 5 of the turbine rotor assembly 50. For example, the turbine blade 5 may not contact, intersect, or form any part of the other turbine blades.

The turbine blade 5 may include a base end 7 as shown in FIGS. 1-3. The base end 7 of the turbine blade 5 may be a portion of the turbine blade 5 that forms a first joint 9 with the intermediate component 10. For example, the base end 7 of the turbine blade 5 may protrude out of the turbine blade 5. The base end 7 is the portion of the turbine blade 5 that bonds with the intermediate component 10. The base end 7 of the turbine blade 5 may be separate and distinct from the base ends 7 of other turbine blades 5 located in the turbine rotor assembly 50 (best shown in FIG. 3). The turbine blade 5 may include a portion that extends from the base end 7 of the turbine blade 5 independent of the other blades of the turbine rotor assembly 50. Additionally or alternately, the base end 7 of the turbine blade 5 may be separate and distinct from other turbine blades 5 on the turbine rotor assembly 50.

The base end 7 of the radial turbine blade 5 includes a discrete bonding surface that attached to the first bonding area located on the outer surface of the intermediate component 10, thereby forming the first joint 9. The bonding surface of the radial turbine blade 5 may conform to the contours of the first bonding area of the intermediate component 10. For example, the discrete bonding surface of the radial turbine blade 5, or a portion thereof, may be substantially flat. Alternatively, the discrete surface of the radial turbine blade 5 may follow other contours when desired.

The rotor disc 15 may include an outer surface that is positioned radially outward from the rotational axis 55 of the rotor disc 15. The outer surface of the rotor disc 15 may include one or more bonding areas. The bonding area is a portion of the outer surface of the rotor disc 15 designated to receive the second bonding surface of the intermediate component 10, thereby forming a second joint 13. The rotor disc 15 may include a plurality of bonding areas. Each of the bonding areas may be separate and distinct from other bonding areas on the outer surface of the rotor disc 15. For example, each bonding area may not join, intersect, or otherwise form any portion of any of the other bonding areas on the outer surface of the rotor disc 15, such that each bonding area forms a separate second joint 13 with different intermediate components 10 (best shown in FIG. 3).

When desirable, the rotor disc 15 may include additional features that affect one or more properties associated with the rotor disc 15 or the formation of the second joint 13 with the intermediate component 10. Such features may include but not be limited to, one or more saddles, fillets, lugs, or combinations thereof.

One of the many advantages of individually attaching the turbine blades 5 with an intermediate component 10, and a rotor disc 15 is that various cooling features and configurations that may optionally be included. These cooling features may be included on or in the turbine blade 5, the rotor disc 15, the intermediate component 10, and/or other components of the turbine engine when desirable. These cooling features may be configured to direct the flow of a cooling fluid received from a cooling fluid source. Such cooling features and configurations on the turbine rotor assembly 50 may enhance the structural integrity, and other design considerations, of the turbine rotor assembly 50 and/or other components of the turbine engine. Examples of such cooling features, include without limitation, one or more cooling holes 3 as illustrated in FIGS. 1 and 3 or cooling passages located within the turbine blade. Thus, turbine blades 5 of the present disclosure may be solid (uncooled), hollow (uncooled or cooled) that are cast or Castbond™ (e.g., includes a coversheet bonded to a spar) of single crystal or equiaxed materials.

When desirable, the turbine assembly 50 may include components alternatively, or in addition, to the rotor disc 15, the intermediate components 10, and the turbine blades 5. These components may be bonded in various manners to maximize feasibility, structural integrity, and to take into account other design considerations of the turbine engine.

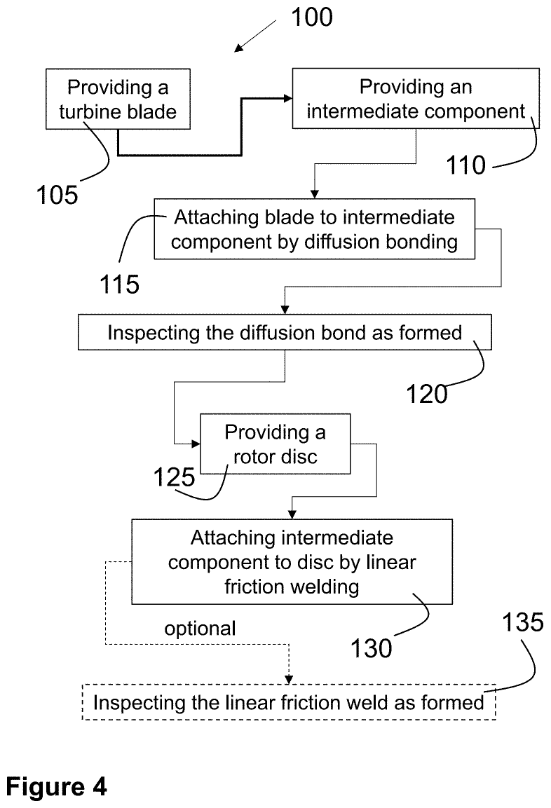

According to another aspect of the present disclosure, a method of forming a turbine blisk is provided. Referring now to FIG. 4, the method 100 generally comprises providing 105 a turbine blade; providing 110 an intermediate component; attaching 115 the turbine blade to the intermediate component to form a first joint having a diffusion bond; inspecting 120 the integrity of the diffusion bond as formed; providing 125 a rotor disc; attaching 130 the intermediate component to the rotor disc to form a second joint having a linear friction weld. Optionally, the method 100 may further comprise inspecting 135 the linear friction weld of the second joint.

The step of providing 105 the turbine blade includes forming a mixture of metals and casting the mixture in a way known to one skilled in the art to result in the turbine blade being comprised substantially of a single giant “grain,” i.e. one continuous crystal. The casting method may be described as “directional solidification.” The casting method generally involves slowly cooling a cast metal part starting at one end to guarantee a particular orientation of its crystal structure chosen based on the expected stresses to which the finished part will be subjected during use. This step may also comprise the use of a Castbond™ process enables a spar comprising the single crystal or equiaxed materials to be protected with one or more overlays or coversheets of, for example, another alloy material. The bond between the two materials forms primarily in the solid-state by diffusions processes.

The steps of providing 110 the intermediate component and/or providing 125 the rotor disc may include, but not be limited the use of one or more manufacturing processes metal powder metallurgy techniques, such as for example, vacuum induction melting, investment casting, vacuum arc remelting, ingot conversion, spray forming/casting, deformation processing, high temperature heat treatment, or a combination thereof.

The step of attaching 115 the turbine blade to the intermediate component to form a first joint having a diffusion bond may include aligning the discrete bonding surface located on the base end of the turbine blade with the first bonding surface located on the intermediate component. The subsequent application of a high temperature and pressure between the two surfaces forced into contact with each other results in the interdispersion of atoms between the two surfaces and the formation of a diffusion bonded joint.

The step of inspecting 120 the integrity of the second joint may include the use of one or more conventional bond inspection techniques, such as for example, sonar inspection. The inspection of the first joint may ensure that a stress bond between the turbine blade and the intermediate component will exhibit adequate performance when the turbine blisk is used in a predetermined application, such as in a turbine engine.

The step of attaching 130 the intermediate component to the rotor disc to form a second joint having a linear friction weld may include aligning the second bonding surface of the intermediate component with one of the bonding areas on the outer surface of the rotor disc. The bonding area of the rotor disc and the second bonding surface of the intermediate component are forced together. Then at least one of the rotor disc and the intermediate component is oscillated at high frequency, thereby causing the friction generated between the two parts to heat the surfaces that are in contact with each other to a temperature at which they become welded together.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The subject-matter of the disclosure may also relate, among others, to the following Aspects:

1. A turbine blisk for use in a gas turbine engine, the turbine blisk comprising:

a turbine blade that includes a base end, the base end having a discrete bonding surface;

an intermediate component, the intermediate component having a first bonding surface and a second bonding surface; and

a portion of a rotor disc having an outer surface, the outer surface including a bonding area;

wherein the discrete bonding surface of the base end of the turbine blade is attached to the first bonding surface of the intermediate component, thereby forming a first joint, the first joint being a diffusion bond;

wherein the second bonding surface of the intermediate component is attached to the bonding area of the outer surface of the rotor disc, thereby forming a second joint, the second joint being a linear friction weld.

2. The turbine blisk according to Aspect 1, wherein the turbine blade is separate and distinct from other turbine blades that are bonded or welded to the rotor disc.
3. The turbine blisk according to any of Aspects 1 or 2, wherein the turbine blade further comprises at least one of a single crystal material or an equiax material.
4. The turbine blisk according to any of Aspects 1-3, wherein the rotor disc and the intermediate component are comprised of a similar material.
5. The turbine blisk according to any of Aspects 1-4, wherein the rotor disc and the intermediate component comprise a metal-based superalloy.
6. The turbine blisk according to any of Aspects 1-5, wherein the rotor disc and the intermediate component comprises a nickel-based superalloy.
7. The turbine blisk according to any of Aspects 1-6, wherein the bonding area of the rotor disc is substantially flat.
8. The turbine blisk according to any of Aspects 1-7, wherein the base end of the turbine blade includes a base surface that is substantially flat, wherein the flat base surface is the discrete bonding surface that is attached to the first bonding surface of the intermediate component.
9. The turbine blisk according to any of Aspects 1-8, wherein the first bonding surface and the second bonding surface of the intermediate component are substantially flat.
10. A turbine rotor assembly for a gas turbine engine, the turbine rotor comprising:

a rotor disc including an outer surface, the outer surface including one or more bonding areas;

a plurality of turbine blades; wherein each turbine blade includes a base end having a discrete bonding surface; and

a plurality of intermediate components with each intermediate component having a first bonding surface and a second bonding surface;

wherein the discrete bonding surface of each turbine blade is attached to the first bonding surface of one of the intermediate components by a diffusion bond and the second bonding surface of each of the intermediate components is attached to one of the discrete bonding surfaces of the rotor disc by a linear friction weld;

wherein each of the turbine blades is separate and distinct from the other turbine blades that are attached to the turbine rotor.

11. The turbine rotor assembly according to Aspect 10, wherein each of the turbine blades comprises a cooling feature.
12. The turbine rotor assembly according to any of Aspects 10 or 11, wherein the base end of the turbine blade includes a cooling hole.
13. The turbine rotor assembly according to any of Aspects 10-12, wherein the turbine blades comprise at least one of a single crystal material or an equiax material;

wherein the disc and the intermediate component comprise a superalloy formed from a powder metal.

14. The turbine rotor assembly according to Aspect 13, wherein the superalloy is a nickel-based superalloy
15. A method of forming a turbine blisk, the method comprising:

providing a turbine blade that includes a base end, the base end having a discrete bonding surface;

providing an intermediate component, the intermediate component having a first bonding surface and a second bonding surface;

attaching the discrete bonding surface of the base end of the turbine blade to the first bonding surface of the intermediate component, thereby forming a first joint, the first joint being a diffusion bond;

inspecting the integrity of the first joint to ensure the joint will exhibit satisfactory performance in a predetermined application;

providing a portion of a rotor disc having an outer surface, the outer surface including a bonding area; and

attaching the second bonding surface of the intermediate component to the bonding area of the outer surface of the rotor disc, thereby forming a second joint, the second joint being a linear friction weld.

16. The method according to Aspect 15, wherein the method further comprises inspecting the linear friction weld of the second joint.
17. The method of according to any of Aspects 15 or 16 wherein the turbine blade comprises at least one of a single crystal material or an equiax material

wherein the intermediate component and the rotor disc comprise a metal-based superalloy

18. The method according to any of Aspects 15-17, wherein the discrete bonding surface of the turbine blade, the first and second bonding surfaces of the intermediate component, and the bonding area on the outer surface of the rotor disc are substantially flat.
19. The method according to any of Aspects 15-18, wherein the step of providing at least one of the turbine blade, the intermediate component, or the rotor disc involves a casting process.
20. The method according to Aspect 17, wherein the metal-based superalloy is a nickel-based superalloy.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A turbine blisk for use in a gas turbine engine, the turbine blisk comprising:
a turbine blade that includes a base end, the base end having a discrete bonding surface;
an intermediate component, the intermediate component having a first bonding surface and a second bonding surface; and
a portion of a rotor disc having an outer surface, the outer surface including a bonding area;
wherein the discrete bonding surface of the base end of the turbine blade is attached to the first bonding surface of the intermediate component, thereby forming a first joint, the first joint being a diffusion bond;
wherein the second bonding surface of the intermediate component is attached to the bonding area of the outer surface of the rotor disc, thereby forming a second joint, the second joint being a linear friction weld.

2. The turbine blisk according to claim 1, wherein the turbine blade is separate and distinct from other turbine blades that are bonded or welded to the rotor disc.

3. The turbine blisk according to claim 1, wherein the turbine blade further comprises at least one of a single crystal material or an equiax material.

4. The turbine blisk according to claim 1, wherein the rotor disc and the intermediate component are comprised of a similar material.

5. The turbine blisk according to claim 4, wherein the rotor disc and the intermediate component comprise a metal-based superalloy.

6. The turbine blisk according to claim 5, wherein the rotor disc and the intermediate component comprises a nickel-based superalloy.

7. The turbine blisk according to claim 1, wherein the bonding area of the rotor disc is substantially flat.

8. The turbine blisk according to claim 1, wherein the base end of the turbine blade includes a base surface that is substantially flat, wherein the flat base surface is the discrete bonding surface that is attached to the first bonding surface of the intermediate component.

9. The turbine blisk according to claim 1, wherein the first bonding surface and the second bonding surface of the intermediate component are substantially flat.

10. A turbine rotor assembly for a gas turbine engine, the turbine rotor comprising:
a rotor disc including an outer surface, the outer surface including one or more bonding areas;
a plurality of turbine blades; wherein each turbine blade includes a base end having a discrete bonding surface; and
a plurality of intermediate components with each intermediate component having a first bonding surface and a second bonding surface;
wherein the discrete bonding surface of each turbine blade is attached to the first bonding surface of one of the intermediate components by a diffusion bond and the second bonding surface of each of the intermediate components is attached to one of the discrete bonding surfaces of the rotor disc by a linear friction weld;
wherein each of the turbine blades is separate and distinct from the other turbine blades that are attached to the turbine rotor.

11. The turbine rotor assembly according to claim 10, wherein each of the turbine blades comprises a cooling feature.

12. The turbine rotor assembly according to claim 11, wherein the base end of the turbine blade includes a cooling hole.

13. The turbine rotor assembly according to claim 10, wherein the turbine blades comprise at least one of a single crystal material or an equiax material;
wherein the disc and the intermediate component comprise a superalloy formed from a powder metal.

14. The turbine rotor assembly according to claim 13, wherein the superalloy is a nickel-based superalloy

15. A method of forming a turbine blisk, the method comprising:
providing a turbine blade that includes a base end, the base end having a discrete bonding surface;
providing an intermediate component, the intermediate component having a first bonding surface and a second bonding surface;
attaching the discrete bonding surface of the base end of the turbine blade to the first bonding surface of the intermediate component, thereby forming a first joint, the first joint being a diffusion bond;
inspecting the integrity of the first joint to ensure the joint will exhibit satisfactory performance in a predetermined application;
providing a portion of a rotor disc having an outer surface, the outer surface including a bonding area; and
attaching the second bonding surface of the intermediate component to the bonding area of the outer surface of the rotor disc, thereby forming a second joint, the second joint being a linear friction weld.

16. The method according to claim 15, wherein the method further comprises inspecting the linear friction weld of the second joint.

17. The method of claim 15 wherein the turbine blade comprises at least one of a single crystal material or an equiax material
wherein the intermediate component and the rotor disc comprise a metal-based superalloy

18. The method of claim 15, wherein the discrete bonding surface of the turbine blade, the first and second bonding surfaces of the intermediate component, and the bonding area on the outer surface of the rotor disc are substantially flat.

19. The method of claim 15, wherein the step of providing at least one of the turbine blade, the intermediate component, or the rotor disc involves a casting process.

20. The method of claim 17, wherein the metal-based superalloy is a nickel-based superalloy.
